(19) United States
(12) Patent Application Publication
(10) Pub. No.: US 2017/0059323 A1
(43) Pub. Date: Mar. 2, 2017

(54) COMBINATION ELECTRODE FOR DRIVE, DRIVE DETECTION, CORIOLIS DETECTION, AND QUADRATURE COMPENSATION

(71) Applicant: Robert Bosch GmbH, Stuttgart (DE)

(72) Inventors: Mirko HATTASS, Stuttgart (DE); Odd-Axel PRUETZ, Nuertingen (DE)

(21) Appl. No.: 15/245,278

(22) Filed: Aug. 24, 2016

(30) Foreign Application Priority Data
Aug. 28, 2015 (DE) 102015216459.4

(51) Int. Cl. G01C 19/5755

(52) U.S. Cl. CPC G01C 19/5755

(57) ABSTRACT

A method for operating a rotational rate sensor having a substrate and at least one structure movable relative thereto, at least one first and at least one fourth electrodes fastened to the structure, and at least one second, at least one third, at least one fifth, and at least one sixth electrodes fixed to the substrate, the first electrode being situated at least partially between second and third electrodes, the fourth electrode being situated at least partially between fifth and sixth electrodes, in each case in a rest position of the structure and along a direction essentially parallel to a first axis, the structure being excited, in a first task, from a rest position of the structure to an oscillation having a movement component essentially parallel to a second axis running perpendicular to the first axis during at least one first time interval within at least one oscillation period.

### RELATED APPLICATION INFORMATION

The present application claims priority to and the benefit of German patent application no. 10 2015 216 459.4, which was filed in Germany on Aug. 28, 2015, the disclosure of which is incorporated herein by reference.

### FIELD OF THE INVENTION

The present invention is based on a method for operating a rotational rate sensor according to the description herein.

### BACKGROUND INFORMATION

Such a method is believed to be generally discussed in the related art.

### SUMMARY OF THE INVENTION

The present invention for operating a rotational rate sensor has, in comparison with the related art, the advantage that the method enables a reduction of the number of structures in rotational rate sensors, such as drive structure, drive detection structure, Coriolis deflection structure, position return regulation structure, resonance matching structure, and quadrature compensation structure. In this way, smaller, simpler, mechanically more robust and lower-cost rotational rate sensors are enabled having a substrate surface that is smaller compared to the existing art. This is achieved in that, in contrast to the existing art, the first, second, third, fourth, fifth, and sixth electrodes are controlled in such a way that, by applying voltage to the first, second, third, fourth, fifth, and sixth electrodes:
the excitation of the structure is produced, and a deflection of the structure from the rest position essentially parallel to the second axis is acquired in a third method step during at least one third time interval within the oscillation period, disjunct from the first time interval, or
the excitation of the structure is produced and a first frequency of the oscillation is matched with a second frequency of the force action in a fourth method step during at least one fourth time interval within the oscillation period, or
the excitation of the structure is produced and a deflection of the structure from the rest position essentially parallel to the second axis is acquired in a third method step during at least one third time interval within the oscillation period, disjunct from the first time interval, and a first frequency of the oscillation is matched with a second frequency of the force action in a fourth method step during at least one fourth time interval within the oscillation period, or
the excitation of the structure is produced and a deflection of the structure from the rest position essentially parallel to the second axis is detected in a third method step during at least one third time interval within the oscillation period, disjunct from the first time interval, and the force action is detected, or
the excitation of the structure is produced and a deflection of the structure from the rest position essentially parallel to the second axis is acquired in a third method step during at least one third time interval within the oscillation period, disjunct from the first time interval, and a first frequency of the oscillation is matched with the second frequency of the force action in a fourth method step during at least one fourth time interval within the oscillation period, and the force action is detected. In this way, in particular through the combination of a plurality of functionalities in the first, second, third, fourth, fifth, and sixth of electrodes, a method is enabled for operating rotational rate sensors having a substrate surface that is small in comparison to the existing art. A smaller required substrate surface is achieved for example in that, using the method according to the present invention, additional space is won through fewer pads, lower complexity of the wiring, and fewer required separate frames, such as drive frames, Coriolis frames, and detection frames. A further advantage of the method according to the present invention is that a measurement “on location” is enabled, because drive frames and Coriolis frames can for example be combined, thus enabling an offset with regard to drive amplitude and phase.

Advantageous embodiments and developments of the present invention may be learned from the further descriptions herein, and from the description with reference to the drawings.

According to a development, it is provided that to produce the excitation of the structure:
a first voltage, which is below a reference voltage present at the first and fourth electrodes, is applied to the second and third electrodes, and a second voltage that exceeds the reference voltage is applied to the fifth and sixth electrodes, or
a first voltage that exceeds the reference voltage is applied to the second and third electrodes, and a second voltage that is below the reference voltage is applied to the fifth and sixth electrodes. In this way, it is advantageously enabled that, using the first voltage and the second voltage, a force that drives the structure is produced both by the first, second, and third electrodes and also by the fourth, fifth, and sixth electrodes respectively. In this way, it is advantageously enabled that the time curves of the first voltage and of the second voltage can be set such that, in the spectrum of the potential difference, a significant portion is at the frequency of the mechanical drive mode. In addition, a drive of the structure is advantageously enabled along two opposite directions having movement components essentially parallel to the second axis. In addition, in this way a method is provided for operating a rotational rate sensor that, through the clock pulse schema of the excitation of the structure, provides time windows to the electrodes for further functionalities.

According to a development, it is provided that in order to acquire the deflection a third voltage, exceeding the reference voltage present at the first and fourth electrodes, is applied to the second, third, fifth, and sixth electrodes. In this way, it is advantageously enabled that in short time slots a voltage that has a difference from the center ground potential at the first and fourth electrodes is present at the electrodes in such a way that a reading out of capacitances, and thus for example a reading out of the immersion depth of the movable electrodes, is enabled. In addition, in this way a method is provided for operating a rotational rate sensor that, through the clock pulse schema of the acquisition of the deflection of the structure, provides time windows to the electrodes for further functionalities.

According to a development, it is provided that in order to match the first frequency with the second frequency, a temporally constant fourth voltage that exceeds a reference voltage present at the first and fourth electrodes is applied to the second, third, fifth, and sixth electrodes. In this way, it is advantageously enabled that over all electrodes, over an oscillation period, in the time average an effective voltage difference from the center ground potential is present that corresponds for example to the theoretical positive feedback voltage as DC value. For example, one of a plurality of free parameters for achieving this goal is the DC level of the drive voltage.

According to a development, it is provided that for the detection of the force action, a fifth voltage, exceeding the reference voltage present at the first and fourth electrodes, is applied to the second, third, fifth, and sixth electrodes. Advantageously, in this way in short time slots a voltage can be applied to the electrodes that has a difference from the center ground potential at the first and fourth electrodes, in order to enable the reading out of a capacitance, and thus for example of a lateral movement of the movable electrodes essentially parallel to the first axis. For example, the information concerning the lateral movement is evaluated as a measure of the Coriolis deflection or as a measure of the quadrature movement in the ASIC (application-specific integrated circuit). In addition, in this way a method is provided for operating a rotational rate sensor that, through the clock pulse schema of the detection of the force action, provides time windows to the electrodes for further functionalities.

According to a development, it is provided that a further force action, which counteracts the force action essentially with an opposite phase, is applied to the structure in a fifth method step during at least one fifth time interval within the oscillation period that is disjunct from the first and/or third time interval. In this way, advantageously a voltage is applied to the electrodes so that a lateral movement due to the Coriolis force is counteracted. In this way, advantageously a method is provided for operating a rotational rate sensor that, through the clock pulse schema of a position return regulation, provides time windows to the electrodes for further functionalities.

According to a development, it is provided that in order to bring about the further force action a sixth voltage that exceeds the reference voltage present at the first and fourth electrodes is applied to the second and fifth 8electrodes, or a seventh voltage that exceeds the reference voltage is applied to the third and sixth electrodes. Advantageously, in this way the operation is enabled of rotational rate sensors that are smaller, simpler, mechanically more robust, and lower in cost compared to the existing art.

According to a development, it is provided that in a sixth method step a third force action is applied to the structure along a direction essentially parallel to the first axis due to the deflection, during at least one sixth time interval within the oscillation period. In this way, it is advantageously enabled that the method according to the present invention includes a quadrature compensation functionality for the operation of rotational rate sensors that are small compared to the existing art.

According to a development, it is provided that to bring about the third force action, an eighth voltage, which exceeds or falls below the reference voltage present at a first region, essentially broadened in a direction parallel to the first axis, of the first electrode and at a second region, essentially broadened in a direction parallel to the first axis, of the fourth electrode, is applied to a first sub-region of the second electrode and to a second sub-region of the sixth electrode, and/or a ninth voltage that exceeds or falls below the reference voltage is applied to a third sub-region of the third electrode and to a fourth sub-region of the fifth electrode. In this way, it is advantageously enabled that the method according to the present invention includes, in a simple, mechanically robust and low-cost manner, a quadrature compensation functionality for the operation of rotational rate sensors that are small compared to the existing art.

In the various Figures, identical parts are always provided with the same reference characters, and are therefore as a rule each only named or mentioned once.

### BRIEF DESCRIPTION OF THE DRAWINGS

FIG. 1 shows, in a schematic representation, a first rotational rate sensor that can be operated using the method according to the present invention according to an exemplary specific embodiment of the present invention.

FIG. 2 shows, in a schematic representation, a second rotational rate sensor that can be operated with the method according to the present invention according to an exemplary specific embodiment of the present invention.

FIG. 3 shows, in a schematic representation, an application of voltage, usable for the method according to the present invention, to electrodes of a rotational rate sensor that can be operated with the method according to the present invention.

### DETAILED DESCRIPTION

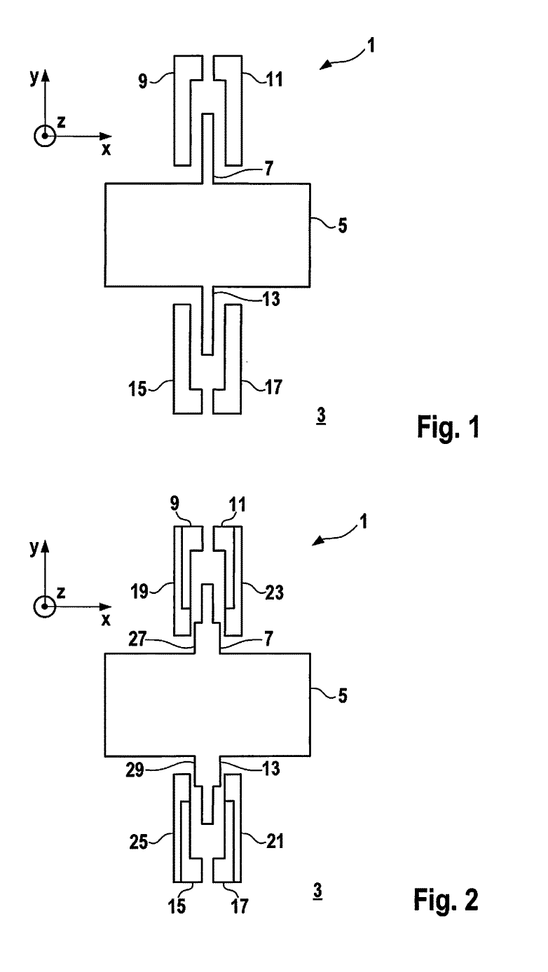

FIG. 1 shows a schematic representation of a first rotational rate sensor 1 that can be operated with the method according to the present invention, or a representation of one of a plurality (not shown) of coupled sub-oscillators according to an exemplary specific embodiment of the present invention. Rotational rate sensor 1 includes a substrate 3, a structure 5 that is movable relative to substrate 3, a first electrode 7 fastened to structure 5, a second electrode 9 fixed to the substrate, a third electrode 11 fixed to the substrate, a fourth electrode 13 fastened to structure 5, a fifth electrode 15 fixed to the substrate, and a sixth electrode 17 fixed to the substrate. Here, first electrode 7 is situated at least partially between second electrode 9 and third electrode 11, and fourth electrode 13 is situated at least partially between fifth electrode 15 and sixth electrode 17, in each case along a direction essentially parallel to a first axis X. For example, electrodes 7, 9, 11, 13, 15, 17 are also designated multi-function electrodes. In FIG. 1, only one electrode pair is respectively shown at top and at bottom. In a concrete realization, these would for example be multiplied.

The rotational rate sensor shown as an example in FIG. 1 is operated in accordance with the method according to the present invention as follows:
in a first method step, structure 5 is excited, from a rest position of structure 5 shown in FIG. 1, to an oscillation having a movement component essentially parallel to a second axis Y during at least one first time interval within at least one oscillation period of the oscillation.
In a second method step, a force action on structure 5 is detected along a direction essentially parallel to first axis X on the basis of a rotational rate of rotational rate sensor 1 about an axis essentially parallel to a third axis Z during at least one second time interval within the oscillation period.

Here, electrodes 7, 9, 11, 13, 15, 17 are controlled in such a way that, through application of voltage to electrodes 7, 9, 11, 13, 15, 17:
the excitation of structure 5 is produced and a deflection of structure 5 from the rest position essentially parallel to second axis Y is acquired in a third method step during at least one third time interval within the oscillation period, disjunct from the first time interval, or
the excitation of structure 5 is produced and a first frequency of the oscillation is matched with a second frequency of the force action in a fourth method step during at least one fourth time interval within the oscillation period, or
the excitation of structure 5 is produced and a deflection of structure 5 from the rest position essentially parallel to second axis Y is acquired in a third method step during at least one third time interval, disjunct from the first time interval, within the oscillation period, and a first frequency of the oscillation is matched with a second frequency of the force action in a fourth method step during at least one fourth time interval within the oscillation period, or
the excitation of structure 5 is produced and a deflection of structure 5 from the rest position essentially parallel to second axis Y is acquired in a third method step during at least one third time interval within the oscillation period, disjunct from the first time interval, and the force action is detected, or
the excitation of structure 5 is produced and a deflection of structure 5 from the rest position essentially parallel to second axis Y is acquired in a third method step during at least one third time interval within the oscillation period, disjunct from the first time interval, and a first frequency of the oscillation is matched with a second frequency of the force action in a fourth method step during at least one fourth time interval within the oscillation period, and the force action is detected.

Through the method according to the present invention, space is saved and thus smaller and lower-cost rotational rate sensor designs are enabled. This is enabled in particular by the combination of a plurality of functionalities in the electrodes, which, for example through multiplication of the electrodes in the X direction, form finger structures or a comb structure. The combination of a plurality of functionalities in a finger structure offers for example the possibility of gaining space due to fewer pads and lower complexity of the wiring. In addition, space is won through topological advantages because separate frames, such as for example in a Ω_{Z} rotational rate sensor, which includes a drive frame, a Coriolis frame, and a detection frame, are no longer necessary. In addition, the method according to the present invention offers the advantage that a measurement “on location” is enabled, because the drive structure and Coriolis structure can be combined, and therefore an offset with regard to drive amplitude and phase can be minimized or avoided.

In the rotational rate sensor shown in FIG. 1, structure 5 is for example suspended, via drive springs and detection springs not shown in FIG. 1, in such a way that a drive movement in the Y direction and a detection movement in the X direction are possible. In addition, the rotational rate sensor shown in FIG. 1 is for example a rotational rate sensor for detecting a rate of rotation about the Z axis. However, the present invention can also be used for the detection of a rate of rotation about the X axis or Y axis, or for the detection of rates of rotation about a plurality of the named axes.

For example, in addition the rotational rate sensor shown in FIG. 1 is operated in such a way that a further force action on structure 5, counteracting the force action essentially with opposite phase, can be brought about in a fifth method step during at least one fifth time interval within the oscillation period, disjunct from the first and/or third time interval.

FIG. 2 shows a schematic representation of a second rotational rate sensor 1 that can be operated using the method according to the present invention, according to an exemplary specific embodiment of the present invention, the rotational rate sensor 1 shown in FIG. 2 corresponding essentially to rotational rate sensor 1 shown in FIG. 1. However, the rotational rate sensor shown in FIG. 2 is in addition capable of being driven in such a way that a third force action on structure 5 is brought about along a direction essentially parallel to first axis X due to the deflection, in a sixth method step during at least one sixth time interval within the oscillation period. In the rotational rate sensor shown as an example in FIG. 2, various electrically separated or insulated regions are realized in a functional layer. Here, in particular second electrode 9 is provided electrically separated, or electrically insulated, from a first subregion 19, and likewise third electrode 11 from a third subregion 23, fifth electrode 15 from a fourth subregion 25, and sixth electrode 17 from a second subregion 21. In this way, an expansion by the quadrature compensation functionality is enabled.

For example, according to the present invention it is provided that a plurality of functionalities are combined in one and the same electrode pair. Examples of functionalities that can be combined are drive force, drive detection, resonance matching, Coriolis detection, position return regulation, and quadrature compensation. Combination with further functionalities is also advantageously conceivable. Exemplary and non-exclusive combinations contain drive force+drive detection, drive force+resonance matching, drive force+drive detection+resonance matching, drive force+drive detection+Coriolis detection, drive force+drive detection+resonance matching+Coriolis detection, and more.

For the method according to the present invention, it is in particular decisive that for the desired combination of functionalities for example a corresponding signal generation and signal evaluation sequence of an electronic controlling is implemented. This is conceivable in that, via time multiplexing, corresponding DC and AC voltages are superposed on the electrodes.

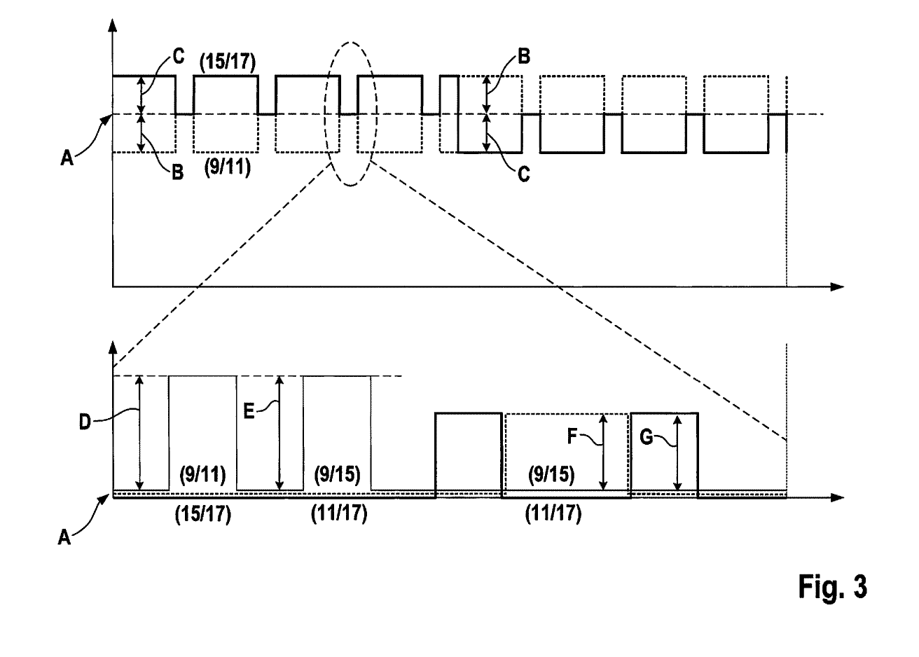

FIG. 3 shows, in a schematic representation, an application of voltage, usable for the method according to the present invention, to electrodes of a rotational rate sensor that can be operated using the method according to the present invention, as electrical potentials plotted over time. This is an exemplary clock pulse schema of a possible wiring. For the drive, here as examples rectangular pulses having short interruptions are used. For example, in the time slots of the interruptions the various functions can be realized for drive detection, Coriolis detection, and position return regulation. In addition, for example in the time slots voltages for quadrature compensation are also applied in a use of a structure as in FIG. 2. However, this is not shown in FIG. 3.

For the functionalities of drive force, drive detection, and resonance matching, for example second and third electrodes 9, 11, or fifth and sixth electrodes 15, 17, are at times wired together.

For example, in order to produce the excitation of structure 5, or to generate a drive force:
a first voltage B, which is below a reference voltage A present at first and fourth electrodes 7, 13, is applied to second and third electrodes 9, 11, and a second voltage C, which exceeds reference voltage A, is applied to fifth and sixth electrodes 15, 17, or
a first voltage B, which exceeds reference voltage A, is applied to second and third electrodes 9, 11, and a second voltage C, which falls below reference voltage A, is applied to fifth and sixth electrodes 15, 17. Here, for example the time curves of the two potentials at electrodes 9, 11 and 15, 17 are such that in the spectrum of the potential difference a significant portion is at the frequency of the mechanical drive mode. This is shown as an example in FIG. 3.

In addition, for example to acquire the deflection or drive detection, a third voltage D, which exceeds reference voltage A present at first and fourth electrodes 7, 13, is applied to second, third, fifth, and sixth electrodes 9, 11, 15, 17. Here, for example in short time slots that repeat for example sixteen times during an oscillation period, a voltage D is present that for example has a difference from the center ground potential at first and fourth electrodes 7, 13, such that the reading out of the capacitance and thus of the immersion depth of the movable fingers is enabled. This is shown as an example in FIG. 3.

In addition, for example for the matching of the first frequency with the second frequency, or for resonance matching, a temporally constant fourth voltage, exceeding reference voltage A present at first and fourth electrodes 7, 13, is applied to second, third, fifth, and sixth electrodes 9, 11, 15, 17. Here, an effective voltage difference from the center ground potential is for example present at all electrodes over an oscillation period in the time average. This voltage difference corresponds for example to the theoretical positive feedback voltage as DC value. For example, one of a plurality of free parameters for reaching this goal is the selection of the DC level of the drive voltage.

For the functionalities of position return regulation and Coriolis detection, for example second and fifth electrodes 9, 15, or third and sixth electrodes 11, 17, are at times wired together.

For example for the detection of the force action, or the Coriolis detection, a fifth voltage E, exceeding reference voltage A present at first and fourth electrodes 7, 13, is applied to second, third, fifth, and sixth electrodes 9, 11, 15, 17. Here, in short time slots that repeat for example sixteen times during an oscillation period, but do not have any overlap with the time slots of the drive detection, a voltage E is applied that has a difference from the center ground potential at electrodes 7, 13, in order for example to enable the reading out of the capacitance and thus the lateral movement of the movable fingers. This is shown as an example in FIG. 3. For example, the information concerning the lateral movement can be evaluated as a measure of the Coriolis deflection or as a measure of the quadrature movement in the ASIC.

In addition, for example to bring about the further force action, or for position return regulation, a sixth voltage F, exceeding reference voltage A present at first and fourth electrodes 7, 13, is applied to second and fifth electrodes 9, 15, or a seventh voltage G, exceeding reference voltage A, is applied to third and sixth electrodes 11, 17. Here, for example similar to the Coriolis detection, but having no overlap therewith, a voltage F, G is respectively applied to electrodes 9, 15, or to electrodes 11, 17, the voltage producing the further force action on structure 5 counteracting the force action, or lateral movement, due to the Coriolis force.

Finally, for example to bring about the third force action, or for quadrature compensation, an eighth voltage, exceeding or falling below reference voltage A present at a first region 27 of first electrode 7 broadened essentially in a direction parallel to first axis X and at a second region 29 of fourth electrode 13 broadened essentially in a direction parallel to first axis X, is applied to a first subregion 19 of second electrode 9 and to a second subregion 21 of sixth electrodes 17, and/or a ninth voltage, exceeding or falling below reference voltage A, is applied to a third subregion 23 of third electrode 11 and to a fourth subregion 25 of fifth electrode 15. For example, the quadrature compensation function is provided in particular by the expansion of first and second region 27, 29, or the connection of the movable fingers. Here an overlap, which is a function of the deflection, respectively between first electrode 7 and first and third subregion 19, 23, as well as between the fourth electrode 13 and second and fourth subregion 21, 25, is provided. Thus, by wiring with different DC voltages between subregions 19, 21, 23, 25, it is possible to produce laterally directed forces that counteract a skewed oscillation, the so-called quadrature movement.

What is claimed is:

1. A method for operating a rotational rate sensor having a substrate and at least one structure movable relative to the substrate, the method comprising:
exciting at least one structure of the rotational rate sensor, in a first task, from a rest position of the structure to an oscillation having a movement component essentially parallel to a second axis running perpendicular to a first axis during at least one first time interval within at least one oscillation period of the oscillation, wherein the rotational rate sensor includes the substrate and the at least one structure, which is movable relative to the substrate, at least one first electrode fastened to the structure, at least one second electrode fixed to the substrate, at least one third electrode fixed to the substrate, at least one fourth electrode fastened to the structure, at least one fifth electrode fixed to the substrate, and at least one sixth electrode fixed to the substrate, the first electrode being situated at least partially between the second electrode and the third electrode, and the fourth electrode being situated at least partially between the fifth electrode and the sixth electrode, in each case in a rest position of the structure and along a direction essentially parallel to the first axis;
detecting a force action on the structure, in a second task, along a direction essentially parallel to the first axis based on a rate of rotation of the rotational rate sensor about an axis essentially parallel to a third axis running perpendicular to the first axis and perpendicular to the second axis during at least one second time interval within the oscillation period, and controlling the first, second, third, fourth, fifth, and sixth electrodes so that, through application of voltage to the first, second, third, fourth, fifth, and sixth electrodes the excitation of the structure is produced, and performing one of the following:
(i) acquiring, in a third task, a deflection of the structure from the rest position essentially parallel to the second axis during at least one third time interval within the oscillation period, disjunct from the first time interval,
(ii) producing the excitation of the structure and matching a first frequency of the oscillation with a second frequency of the force action in a fourth task during at least one fourth time interval within the oscillation period,
(iii) producing the excitation of the structure and acquiring a deflection of the structure from the rest position essentially parallel to the second axis in a third task during at least one third time interval within the oscillation period, disjunct from the first time interval, and a first frequency of the oscillation is matched with a second frequency of the force action in a fourth task during at least one fourth time interval within the oscillation period,
(iv) producing the excitation of the structure and detecting a deflection of the structure from the rest position essentially parallel to the second axis in a third task during at least one third time interval within the oscillation period, disjunct from the first time interval, and the force action is detected, and
(v) producing the excitation of the structure and acquiring a deflection of the structure from the rest position essentially parallel to the second axis in a third task during at least one third time interval within the oscillation period, disjunct from the first time interval, and a first frequency of the oscillation is matched with a second frequency of the force action in a fourth taskduring at least one fourth time interval within the oscillation period, and the force action is detected.

2. The method of claim 1, wherein to produce the excitation of the structure, a first voltage that falls below a reference voltage present at the first and fourth electrodes is applied to the second and third electrodes, and a second voltage that exceeds the reference voltage is applied to the fifth and sixth electrodes, or a first voltage that exceeds the reference voltage is applied to the second and third electrodes, and a second voltage that falls below the reference voltage is applied to the fifth and sixth electrodes.

3. The method of claim 1, wherein to acquire the deflection a third voltage that exceeds a reference voltage present at the first and fourth electrodes is applied to the second, third, fifth, and sixth electrodes.

4. The method of claim 1, wherein to match the first frequency with the second frequency, a temporally constant fourth voltage, exceeding a reference voltage present at the first and fourth electrodes, is applied to the second, third, fifth, and sixth electrodes.

5. The method of claim 1, wherein to detect the force action a fifth voltage, exceeding a reference voltage present at the first and fourth electrodes, is applied to the second, third, fifth, and sixth electrodes.

6. The method of claim 1, wherein a further force action, counteracting the force action essentially with opposite phase, is applied to the structure in a fifth method task during at least one fifth time interval within the oscillation period, disjunct from the first and/or third time interval.

7. The method of claim 6, wherein to bring about the further force action a sixth voltage, exceeding a reference voltage present at the first and fourth electrodes, is applied to the second and fifth electrodes, or a seventh voltage exceeding the reference voltage is applied to the third and sixth electrodes.

8. The method of claim 1, wherein a third force action is applied to the structure along a direction essentially parallel to the first axis due to the deflection, in a sixth method task during at least one sixth time interval within the oscillation period.

9. The method of claim 8, wherein to bring about the third force action, an eighth voltage, which exceeds or falls below the reference voltage present at a first region, essentially broadened in a direction parallel to the first axis, of the first electrode and at a second region, essentially broadened in a direction parallel to the first axis, of the fourth electrode, is applied to a first sub-region of the second electrode and to a second sub-region of the sixth electrode, and/or a ninth voltage that exceeds or falls below the reference voltage is applied to a third sub-region of the third electrode and to a fourth sub-region of the fifth electrode.
